(19) United States
(12) Patent Application Publication
(10) Pub. No.: US 2016/0027303 A1
(43) Pub. Date: Jan. 28, 2016

(54) ACTIVE DETECTION SYSTEM FOR LOW GROUND CLEARANCE VEHICLES

(71) Applicant: Advanced Technology & Research Corp., Columbia, MD (US)

(72) Inventors: Weifeng ZHAO, Ashburn, VA (US); Bryan Ellis WAGENKNECHT, North Bethesda, MA (US); Eric Chi-Kai HUI, Olney, MD (US)

(21) Appl. No.: 14/806,617

(22) Filed: Jul. 22, 2015

Related U.S. Application Data
(60) Provisional application No. 62/027,603, filed on Jul. 22, 2014.

(51) Int. Cl. G08G 1/16

(52) U.S. Cl. CPC G08G 1/165

(57) ABSTRACT

A vehicle ground collision prevention method involves acquiring a geometric profile of a road feature, the geometric profile defining a shape of the upper surface of the road feature, acquiring wheel diameters and inter-axle distances for a vehicle, generating an interference boundary based on the road feature geometric profile, wheel diameters and inter-axle distances, where the interference boundary is an upper envelope bounding the trajectories of all points on the road feature geometric profile as observed in a vehicle-fixed reference frame as the vehicle passes over the road feature, acquiring an underbody profile of the vehicle, the underbody profile defining the shape of the lower surface of the vehicle, calculating a ground clearance curve for the vehicle-road feature pair by comparing the underbody profile with the interference curve, determining a minimum ground clearance over the ground clearance curve, and providing information regarding the minimum ground clearance to the vehicle's driver.

This application claims priority to U.S. Provisional Patent Application Ser. No. 62/027,603, filed Jul. 22, 2014, which is hereby incorporated by reference in its entirety.

### FEDERALLY SPONSORED RESEARCH

The invention that is the subject of this application was developed with federal funding from the DOT Federal Railroad Administration (FRA) through the Small Business Innovation Research (SBIR) program under contracts DTRT57-13-C-10042 and DTRT57-14-C-10028. Accordingly, the applicant retains its rights to the intellectual property created, subjected to the standard patent rights clause as set forth in the Code of Federal Regulations at 37 CFR 401.14. Under this clause the U.S. Government has a nonexclusive, non-transferable, irrevocable, royalty-free license to practice the invention for U.S. Government purposes only.

### FIELD OF THE INVENTION

The present invention relates generally to vehicle safety on roads, in particular, to hang-ups of low ground clearance vehicles at road features such as high-profile railway crossings and other steep grade changes in a roadway.

### BACKGROUND

Roadway-railway high-profile crossings, at which there is an abrupt change in the level of the road surface as it crosses the train tracks, present a hang-up risk to vehicles with low ground clearance. Such high-profile crossings are located throughout the United States, typically on local and collector roads, and occur mostly in rural or small urban areas. High-profile rail crossings are found in many other countries as well. Despite passive signage frequently employed to warn vehicles at high-profile crossings, hang-ups occur and can have severe consequences. Loss of life and extensive property damage results when a vehicle becomes stuck on the hump of a crossing while attempting to traverse it, and then is struck by a train.

The American Railway Engineering and Maintenance-of-Way Association (AREMA) has specified an ideal highway-rail grade crossing profile in its Manual for Railway Engineering (1993). This profile has limited road grades that do not present significant hang-up risks. However, many high-profile crossings do not conform to these guidelines. Some passenger cars have low ground clearance, but the vehicle types involved in most hang-ups are long wheelbase commercial vehicles and trailers. Examples include low-boy heavy equipment trailers, car carrier trailers, low-floor urban transit buses, moving vans and farm equipment trailers. These vehicles or trailers can have consistently low ground clearance or protrusions on the underside that reach down close to the road surface. Such features extending beneath the chassis frame include tanks, storage cabinets, aerodynamic fairings, and trailer stand legs. In general, hang-ups occur where a long span between vehicle/trailer axles has a low-hanging section of chassis. The wide-spread axles can straddle the raised crossing hump, allowing the chassis to reach closer to the road surface and make contact. Overhanging portions of the vehicle that extend forward of the front axles or backward from the rear axles may also contact the road, for example when a level road suddenly transitions to a steep incline.

Passive signage already exists at many high-profile crossings. However, such signage can do no more than highlight a general risk. The driver must guess and hope that his vehicle will not hang up. Absent specific knowledge of the risks to the driver's vehicle at a specific crossing, most drivers will proceed, sometimes with disastrous consequences. There is a need to supply specific and credible risk information to the drivers of at-risk vehicles/trailers.

Many commercial vehicles are already equipped with in-cab communications, route planning and driver monitoring systems. Cellular-based voice and data communication links with drivers are currently ubiquitous. At present, the Federal Railroad Administration (FRA) has its own smartphone application that identifies railroad crossings and supplies basic accident statistics about it. Needs exist for improved systems and methods for delivering vehicle and crossing-specific risk information to drivers.

### SUMMARY

The illustrative embodiment of the invention is a system that utilizes inputted information about the dimensions and underbody profile of a vehicle or trailer under the control of a driver, and about the dimensions and shape of a specific high-profile railway crossing (or other road feature), to make a reliable determination whether the driver's vehicle can transit the subject crossing without hang-up, and furthermore communicate that determination to the driver for timely action. While driver notification can be accomplished by means of active signage in the vicinity of the crossing, with sufficient distance and time for the driver to stop, the illustrative embodiment entails wireless transmission to a location-sensitive device in the vehicle cab and visual and/or audio alerts issued by that device.

In the illustrative embodiment, the hang-up risk assessment and notification system accepts known vehicle/trailer underbody profile (referred to generally as “vehicle underbody profile”) and crossing profile information as inputs. The vehicle underbody profile fully defines the shape of the lower surface of the vehicle to some resolution. For example, it may comprise a number of points on the lower surface of the vehicle, with geometric (x,y,z) coordinates for each point. Each point may be roughly the same distance away from the next closest points. Depending on how the profile is acquired, the resolution may be very high (the points very dense), for example there may be 1,000 or more points in a cubic foot area of the profile. The vehicle/trailer dimensions and underbody profile may be obtained in various ways. For highly standardized trailers, the manufacturer's drawings and specifications suffice. It is also possible to pre-measure a vehicle/trailer underbody at low or zero speed using established sensing methods, such as LIDAR and camera systems at the time and place of DOT registrations or periodic mandatory inspections. Measuring the underbody profile in real-time as a vehicle travels along a roadway at speed is also an option, although much more difficult technically. Road vehicles and trailers have unique identifiers, such as registration numbers issued by state Department of Transportation, permitting vehicle/trailer measurements to be stored in the system in memory/computer readable media well before it needs to be accessed. Any known method of underbody profile measurement collection may be used. Embodiments of the invention utilize previously collected underbody profile measurement information.

Similarly, the measurement of a high-profile crossing can be performed and the result stored in the system in memory/computer readable media before it is needed. High-profile crossings, which are a small subset of the roughly 240,000 road-rail crossings in the United States, can be measured using traditional land survey methods. The US Federal Railroad Administration has a unique identification system for crossings, allowing easy association of a crossing, its location and its geometric profile. This data may be available as an input to the decision-making system. Embodiments of the invention utilize previously collected high-profile crossing measurement information.

A server-based decision-making engine accesses stored geometric information about the vehicle/trailer and crossing and calculates the risk of a hang-up. Key to the analysis is the concept of an “interference boundary”, which is the upper envelope bounding the trajectories of all points on the crossing surface as observed in the vehicle-fixed reference frame. Based on the pre-measured crossing profile, one contoured interference boundary, described in detail below, is generated for the underbody of the vehicle between every two adjacent axles. If any low-hanging portion of the underbody violates the contoured interference boundary, a no-go decision is reached.

In the most general case, an interference boundary consists of a three-dimensional surface defined in a vehicle-fixed coordinate system. A contoured interference boundary enables a more reliable screening process compared to the use of a flat clearance threshold definition (i.e. “minimum ground clearance 12″ for every part of the vehicle”). If a single flat clearance threshold were used, similar to the over-height vehicle detection prior to a tunnel, the screening would fail to account for differences between vehicles as they drive over a crossing, specifically, that vehicles with a smaller wheelbase require less clearance. As a result, a conservative clearance threshold selected to ensure detection of even the worst-case vehicle would result in significant false positive errors (i.e. predicting a hang-up when none would occur). This would misclassify smaller vehicles as hang-up risks, cause wasteful detours and erode confidence in the system.

A flat clearance threshold definition also fails to capture the nuance that since the vehicle's wheels are actually following the road contour and maintaining a constant offset above the road at the wheel location, portions of the vehicle in the wheel's vicinity may actually extend lower than the threshold elevation without risk of hang-up. This would also result in false positive errors, since vehicles with a low-hanging structure near a wheel would be warned to stop regardless of the structure's proximity to the wheel. To significantly reduce such errors, the detection algorithm is based on a contoured interference boundary customized to each vehicle, with a clearance height requirement that varies along the length of the vehicle. If any part of the vehicle extends lower than the interference boundary, a hang-up risk is detected.

Under conditions where the crossing surface can be assumed to be constant from left to right across the width of the vehicle, the dimensionality of the 3D interference boundary surface may be reduced to a 2D interference curve on the centerline plane of the vehicle. The overwhelming majority of high-profile crossings entail a crossing at a near-90 degree angle to the rail tracks and longitudinal axis of the elevated railbed. The detection task then becomes a planar problem that can be executed by comparing a silhouette side-view of the vehicle underbody against its interference curve.

An effective hang-up and overhang detection process is also formulated. The process is a sequential approach which includes the following six steps: 1) acquire the geometry profile of the crossing; 2) acquire the vehicle wheel diameters and inter-axle distances; 3) acquire the vehicle underbody profile; 4) generate the interference boundary for the vehicle/crossing pair; 5) calculate the vehicle clearance; 6) detect if there is any violation, or near-violation of the identified underbody against the compound interference boundary and determine the likelihood of a hang-up.

An additional capability of the system is to adjust for vehicle/trailer loading, which can influence ground clearance. If the vehicle/trailer is not measured in real-time, the system may accept empty-or-full inputs through the in-cab communication device. This status information may be entered through the system user interface at the same time the driver enters the identifier of his vehicle or the trailer he is hauling. Because commercial vehicle/trailer tires and suspensions generally perform predictably under loads, pre-estimated adjustments for loading can be made. In any case, the output of the decision-making engine is expressed in probabilistic terms to account for possible error in factors such as vehicle loading.

Wireless communications, a user interface and an alert notification sub-system support the decision-making engine for the hang-up risk assessment application. This sub-system may be embodied as a mobile device application run in client-server mode from a remote server, having computer-accessible crossing and vehicle profile databases, accessed through the internet and wireless data services. The application may operate independently of other applications available to the vehicle driver; alternatively, it may operate as a well-integrated add-on to an in-cab telemetry or route-planning system, or to an existing smartphone application, such as a localizing and mapping application. The sub-system may be capable of receiving simple, limited inputs from the driver, including the identification number of the trailer or vehicle and its empty or full status for the journey. To the extent that the driver's device (e.g. smartphone) has a built-in scanner, the vehicle/trailer identifier may be scanned rather than entered by hand. The sub-system may prompt the driver for such inputs.

The sub-system requests hang-up determinations for relevant crossings from the decision-making engine. Several determinations at a time may be requested if the system is being used for route planning Otherwise, the sub-system may request determinations for just the high-profile crossings within a limited, predetermined radius of the current position of the vehicle. The sub-system may use either its own GPS or cell service-triangulation data, or utilize such information supplied by a supporting localizer and mapping application in order to geo-localize its location. Because the calculation of hang-up results on the server may be nearly instantaneous and most input information may be already stored on the server, thereby keeping wireless bandwidth requirements very low, the results of the calculations and alerts to the driver may be communicated in near real-time. Determinations may be communicated wirelessly over the cellular network to the in-cab device or smartphone for visual display and supplemental audible signaling. The probabilistic results in embodiments may be simplified, as determined by the system administrator, to basic “OK to proceed”, “Proceed very slowly with caution”, or “Do not cross” commands.

A new vehicle ground collision prevention system includes one or more processing devices configured to execute computer program modules. The computer program modules may include a vehicle information module configured to obtain an underbody profile, wheel diameters, and inter-axle distances for a vehicle, a road feature profile module configured to obtain a geometric profile of a road feature, an interference boundary module configured to generate an interference boundary based on the road feature geometric profile and the wheel diameters and inter-axle distances of the vehicle, wherein the interference boundary is an upper envelope bounding the trajectories of all points on the road feature geometric profile as observed in a vehicle-fixed reference frame as the vehicle passes over the road feature, a ground clearance calculation module configured to calculate a ground clearance curve for the vehicle-road feature pair by comparing the underbody profile of the vehicle with the interference curve and to determine a minimum ground clearance over the ground clearance curve, and a communication module configured to provide information regarding the minimum ground clearance to the vehicle's driver. The underbody profile may include vehicle wheel diameters and inter-axle distances, or this information may be computed from the underbody profile.

The vehicle information module may be further configured to obtain a loading condition of the vehicle and the ground clearance calculation module may be configured to take the loading condition of the vehicle into account in calculating the ground clearance curve.

The computer program modules may also include a threshold warning module configured to determine whether the minimum ground clearance is below a threshold level and, responsive to a determination that the minimum ground clearance is below the threshold level, to indicate a warning for a driver of the vehicle of a possible collision should the vehicle attempt to traverse the road feature.

The computer program modules may also include a simplification module configured to determine whether the height of the geometric profile of the road feature is constant across the width of the road and, responsive to a determination that the height of the geometric profile of the road feature is constant across the width of the road, to collapse the geometric profile to two dimensions by eliminating a road-width dimension from the geometric profile and to collapse the underbody profile of the vehicle to two dimensions by removing a vehicle-width dimension from the underbody profile and setting the vehicle height at each point from the front to the back of the vehicle as the lowest height along the width of the vehicle at that front-to-back point.

The communication module may be configured to provide information regarding the minimum ground clearance to the vehicle's driver by transmitting the information to a remote server associated with an in-cab wireless communication device.

The vehicle ground collision prevention system may also include a road feature database and a vehicle database, where the vehicle information module is configured to retrieve information from the vehicle database and the road feature information module is configured to retrieve information from the road feature database.

The vehicle ground collision prevention system may also include an identification tag physically located on the vehicle and a scanner local to the road feature configured to read identification information from the identification tag for use in retrieving vehicle information from a vehicle information database.

The vehicle ground collision prevention system may also include a web server, where one or more of the computer program modules reside on the web server.

One or more of the computer program modules may reside on a computing device local to the driver of the vehicle.

A new vehicle ground collision prevention method may include acquiring a geometric profile of a road feature, the geometric profile defining a shape of the upper surface of the road feature, acquiring wheel diameters and inter-axle distances for a vehicle, generating an interference boundary based on the road feature geometric profile, wheel diameters and inter-axle distances, where the interference boundary is an upper envelope bounding the trajectories of all points on the road feature geometric profile as observed in a vehicle-fixed reference frame as the vehicle passes over the road feature, acquiring an underbody profile of the vehicle, the underbody profile defining the shape of the lower surface of the vehicle, calculating a ground clearance curve for the vehicle-road feature pair by comparing the underbody profile of the vehicle with the interference curve, determining a minimum ground clearance over the ground clearance curve, and providing information regarding the minimum ground clearance to the vehicle's driver.

The vehicle ground collision prevention method may also include determining whether the minimum ground clearance is below a threshold level and, responsive to a determination that the minimum ground clearance is below the threshold level, indicating a warning for a driver of the vehicle of a possible collision should the vehicle attempt to traverse the road feature as part of providing information regarding the minimum ground clearance to the vehicle's driver.

The vehicle ground collision prevention method may also include acquiring a loading condition for the vehicle, where calculating the ground clearance curve includes adjusting for loading condition by increasing calculated ground clearance under an unloaded condition and decreasing calculated ground clearance under a loaded condition.

The vehicle ground collision prevention method may also include determining whether the height of the geometric profile of the road feature is constant across the width of the road and, responsive to a determination that the height of the geometric profile of the road feature is constant across the width of the road, collapsing the geometric profile to two dimensions by eliminating a road-width dimension from the geometric profile and collapsing the underbody profile of the vehicle to two dimensions by removing a vehicle-width dimension from the underbody profile and setting the vehicle height at each point from the front to the back of the vehicle as the lowest height along the width of the vehicle at that front-to-back point.

Generating the interference boundary may include, for each point in the geometric profile of the road feature, calculating a trajectory of the point in the vehicle-fixed reference frame as the vehicle passes over the point, the trajectory starting when the forward-most portion of the vehicle enters the space above the point and ending when the rear-most portion of the vehicle leaves the space above the point, determining at each point along the non-height dimension(s) of the underbody profile in the vehicle-fixed reference frame the greatest height of any point trajectory, and aggregating the greatest heights to form the interference boundary. In such case, the vehicle ground collision prevention method may also include determining whether the height of the geometric profile of the road feature is constant across the width of the road and, responsive to a determination that the height of the geometric profile of the road feature is constant across the width of the road, collapsing the geometric profile to two dimensions by eliminating a road-width dimension from the geometric profile and collapsing the underbody profile of the vehicle to two dimensions by removing a vehicle-width dimension from the underbody profile and setting the vehicle height at each point from the front to the back of the vehicle as the lowest height along the width of the vehicle at that front-to-back point, where the non-height dimension(s) of the underbody profile includes front-to-back length only.

Calculating a ground clearance curve for the vehicle-road feature pair may include, at each point along the non-height dimension(s) of the underbody profile in the vehicle-fixed reference frame, subtracting the height of the interference boundary from the height of the underbody profile of the vehicle.

Acquiring the geometric profile of the road feature and the underbody profile of the vehicle may include retrieving the geometric profile and the underbody profile from databases.

Providing information regarding the minimum ground clearance to the vehicle's driver may include transmitting the information to a remote server associated with an in-cab wireless communication device. For example, the driver may use a driver assistance device built into the vehicle, which communicates with an associated remote server to keep the vehicle owner, driver's employer or other party informed about the status of the vehicle and/or driver and the driver informed of relevant information pertaining to the vehicle (e.g. maintenance information, location) and the route driven (e.g. speed limits, red light cameras, traffic, route changes, detours, etc.). The minimum ground clearance information may be transmitted to this remote web server so that the information can be processed as desired by the vehicle owner or etc. and communicated in the desired form (e.g. a certain warning or alarm or more specific information) to the driver via the driver assistance device. In some such embodiments the driver assistance device may be an app built into the driver's smart phone or other mobile device rather than built into the vehicle.

These and further and other objects and features of the invention are apparent in the disclosure, which includes the above and ongoing written specification, with the drawings.

### BRIEF DESCRIPTION OF THE DRAWINGS

The accompanying drawings, which are incorporated herein and form a part of the specification, illustrate exemplary embodiments and, together with the description, further serve to enable a person skilled in the pertinent art to make and use these embodiments and others that will be apparent to those skilled in the art. The invention will be more particularly described in conjunction with the following drawings wherein:

FIG. 1 is a flowchart that illustrates a step-by-step hang-up and overhang detection process for low ground clearance vehicles, in an embodiment.

FIG. 2 illustrates the concept of a trajectory that is generated by any point on the crossing surface when observed in the vehicle-fixed reference frame.

FIG. 3 is a diagram that illustrates the concept of an interference boundary and how it is generated from the trajectories of multiple points on the crossing surface when observed in the vehicle-fixed reference frame.

FIG. 4 is a diagram that illustrates how to reach a go/no-go decision by comparing the underbody profile against the interference boundary, in an embodiment.

FIG. 5 is a diagram illustrating the architecture of the communications sub-system, in an embodiment.

FIG. 6 depicts a network topology for active detection for low ground clearance vehicles, in an embodiment.

### DETAILED DESCRIPTION

An active detection system for low ground clearance vehicles will now be disclosed in terms of various exemplary embodiments. This specification discloses one or more embodiments that incorporate features of the invention. The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may affect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted.

The description is not to be taken in a limiting sense, but is made merely for the purpose of illustrating the general principles of the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an” and “the” are intended to include the plural forms as well, unless the context clearly indicates otherwise.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

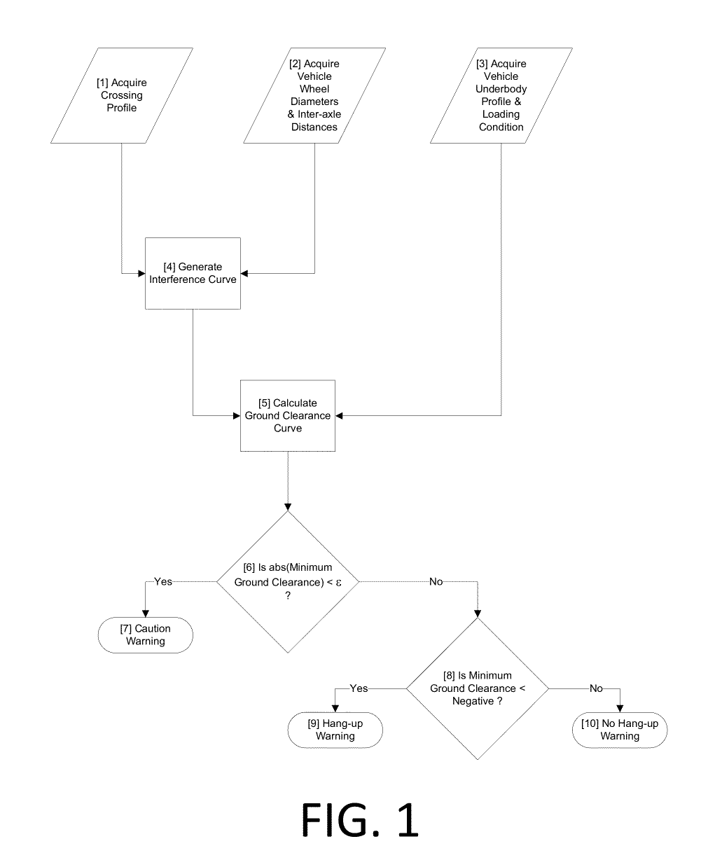

FIG. 1 is an active detection system flowchart. The steps are not necessarily performed in the order they are numbered. Step 1 is to obtain the pre-measured geometric profile of the crossing. The geometric profile fully defines the shape of the crossing to some resolution. For example, it may comprise a number of points on the surface of the crossing, with geometric (x,y,z) coordinates for each point. Each point may be roughly the same distance away from the next closest points. Depending on how the profile is acquired, the resolution may be very high (the points very dense), for example there may be 1,000 or more points in a cubic foot area of the profile. The geometric profile may be obtained by a laser profilometer and assumed to be prior knowledge at the time of the detection event. Whenever the road in the vicinity of the crossing or the crossing itself is modified or reworked, the geometry may be rescanned. Step 2 is to acquire vehicle wheel diameters and inter-axle distances. Step 3 is to acquire a vehicle underbody profile and loading condition. Based on the information acquired in Step 1 and Step 2, an interference curve is generated in Step 4. In Step 5, the ground clearance curve is computed by comparing the vehicle underbody profile acquired in Step 3 and the interference curve generated in Step 4. The decision-making engine classifies the vehicle into one of the three categories. If the computed clearance is too small, the system generates a caution warning such as “Proceed Slowly and with Caution.” The vehicle may proceed slowly but should be prepared to stop (Step 7). If the computed clearance is sufficiently less than zero (e.g. 1 cm), the vehicle will certainly have a hang-up problem at the crossing. The system triggers a hang-up warning such as “Do Not Cross” (Step 9). If the computed clearance is sufficiently greater than zero (e.g. 1 cm), on the other hand, the vehicle can safely pass the crossing. The system generates a message such as “Proceed” (Step 10).

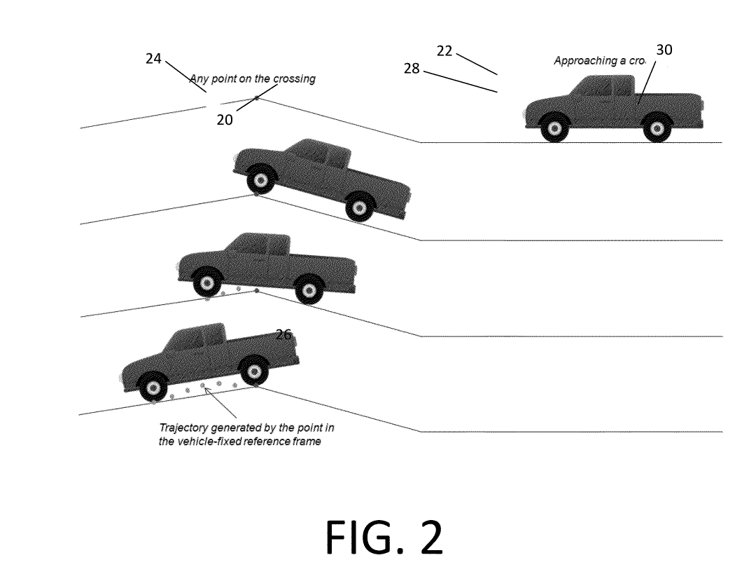

FIG. 2 illustrates the concept of a trajectory that is generated by any point on the crossing surface when observed in the vehicle-fixed reference frame. When a vehicle 22 is passing a crossing, any point 20 on the crossing surface 24 will generate a trajectory 26 under the vehicle when observed in the vehicle-fixed reference frame—that is, from the perspective of an observer on the vehicle. The trajectory starts when the forward-most portion of the vehicle 28 enters the space above the point 20 and ends when the rear-most portion 30 of the vehicle leaves the space above the point 20. The shape of the trajectory depends on two factors—the geometric profile of the crossing and the wheelbase (distances between axles and between wheels on the same axle) of the vehicle. If the crossing is flat, for instance, the trajectory of any point on the crossing surface will also be flat in the vehicle-fixed reference frame no matter how wide or narrow the vehicle wheelbase is. If the crossing is a hump, any point on the crossing surface will generate a trajectory under the vehicle. In general, the wider the wheelbase is, the steeper the trajectory becomes.

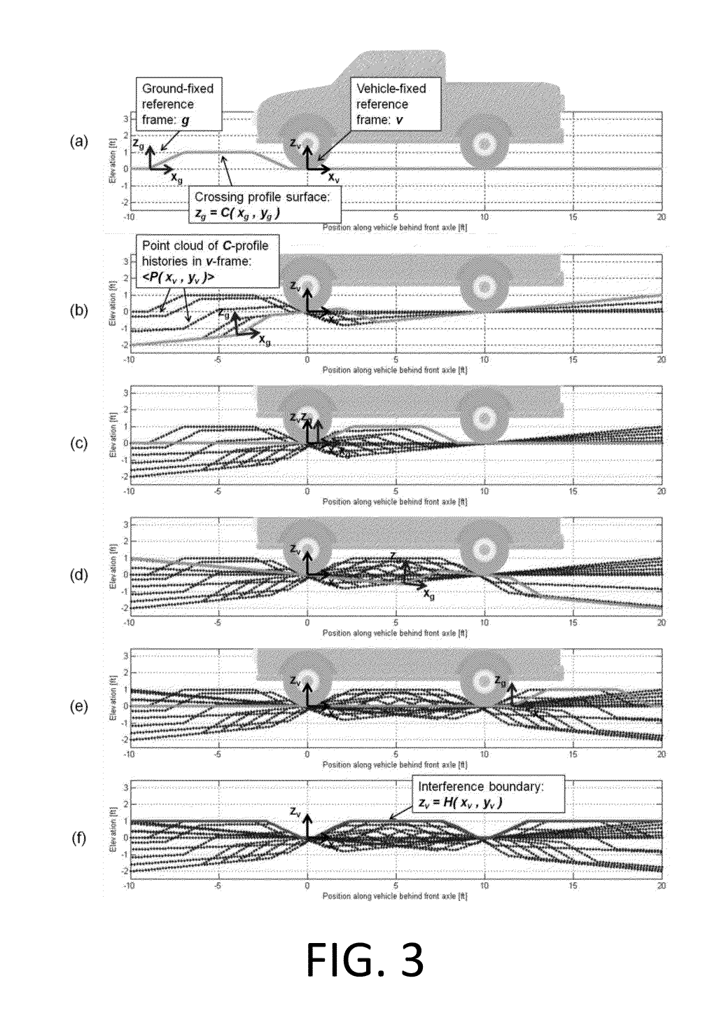

FIG. 3 illustrates the concept of the interference boundary, which is the upper envelope bounding the trajectories of all points on the crossing surface as observed in the vehicle-fixed reference frame. While the interference boundary is defined most generally as a continuous surface in three-dimensional space, this figure depicts a two-dimensional boundary curve for clarity. To more explicitly define the interference boundary and describe how it is generated, we first define the geometry profile of the crossing surface C in three dimensions according to the function z=C(x,y) in a ground-fixed reference frame g (FIG. 3a), where x is left to right, y is front to back, and they form a baseline horizontal plane. z is the crossing surface elevation above the horizontal plane. When the elevation z along y axis is a constant, the crossing surface can be simplified as a crossing curve as illustrated in FIG. 3a. A hang-up is assumed to occur when some part of the vehicle comes into contact with this surface during its traverse of the crossing, or extends into the volume below the surface. Given the vehicle's wheelbase length l_{wb} (distance between consecutive axles), wheelbase width w_{wb} (distance between wheels on the same axle), and tire diameter dₜᵢᵣₑ, a simulation of the vehicle driving over the crossing is executed. At each time step t of the simulation, the coordinates of regularly sampled points on surface C are recorded as measured in a vehicle-fixed reference frame v (FIGS. 3b-e). The spacing of these sample points affects the granularity of the eventual interference boundary and in practice is dictated by the spacing of survey measurements taken of the real-world crossing. Thus, once the simulated vehicle has driven entirely beyond surface C at time t=T, a large cloud of points representing the time history of the crossing profile has been collected in the vehicle reference frame:

[symbol]

P [symbol] = [symbol] [symbol] C [symbol] |ᵥ^{t=1}, [symbol] C [symbol] |ᵥ^{t=2}, . . . , [symbol] C [symbol] |ᵥ^{t=T}, given l_{wb},W_{wb},dₜᵢᵣₑ

This point cloud [symbol] P [symbol] and all volume below it comprises a region in vehicle space into which no part of the vehicle should extend. The surface H forming the upper bound of this cloud becomes the interference boundary (FIG. 3f), defined as

z=H(x,y)= [symbol] max(P(x,y))|_{(x,y)} [symbol] for (x,y)εvehicle

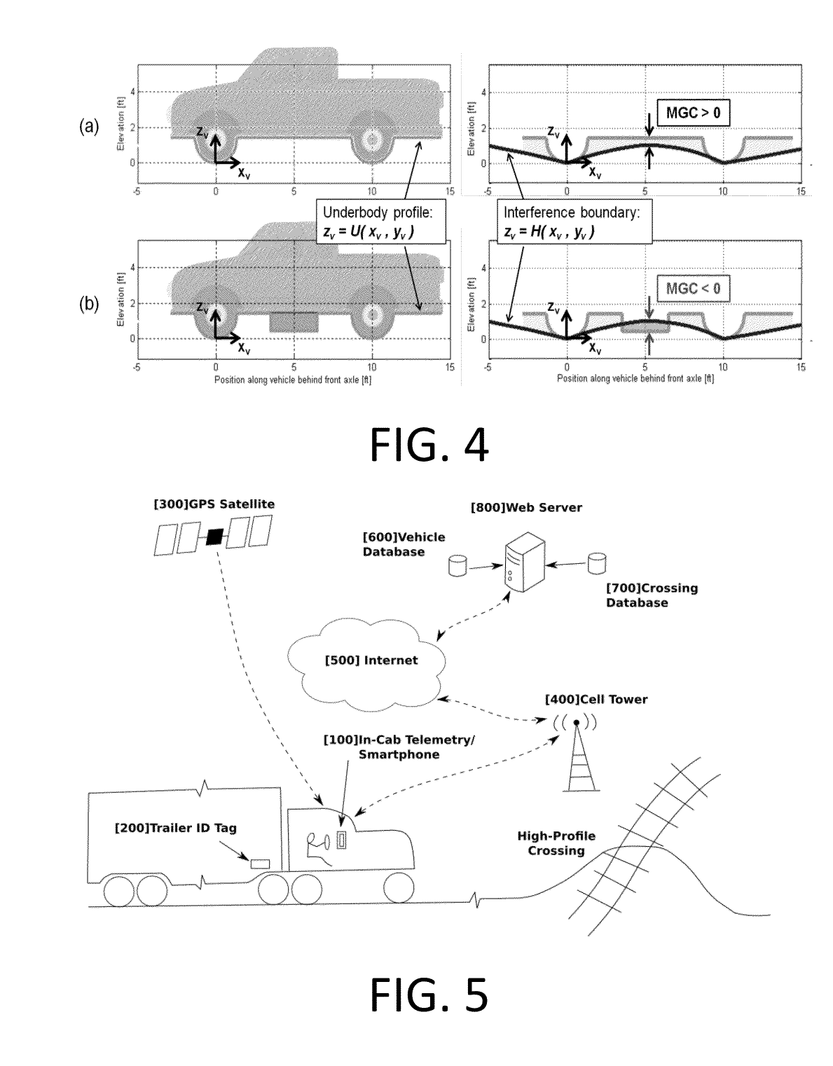

FIG. 4 illustrates how to reach a go/no-go decision-making process. Again, the most general form of the decision process considers hang-ups in three-dimensional space. This figure depicts a two-dimensional (planar) decision process for clarity. With the underbody profile of the vehicle in the v coordinate system defined according to the function z=U(x,y), where z is the elevation of the vehicle underbody above a flat road surface and (x,y) is the Cartesian location in the horizontal plane with origin below the front axle at the vehicle centerline, the detection is performed by calculating the ground clearance in coordinate system v as,

G=U(x,y)−H(x,y)

and then identifying the minimum ground clearance (FIG. 4a)

$$M G C = {min}_{( x , y ) ∈ vehicle} G ( x , y )$$

If MGC is less than some minimum threshold (FIG. 4b), a collision is predicted and the vehicle should be prevented from traversing the grade crossing. If the collision is between wheels, the scenario is called a hang up. If it happens at the front or rear end of the vehicle, the scenario is called an overhang collision. The minimum threshold may be set to zero as illustrated, or may be somewhat greater than zero to account for the possibility of measurement and other errors. There may be multiple thresholds resulting in different warnings being sent to the driver. For example, if MGC is less than zero a warning may be provided that the driver must stop or the vehicle will experience a hang-up or overhang collision. If MGC is less than an inch, a warning may be provided that a hang-up is possible and a detour should be taken. If MGC is between one and two inches, a warning may be provided that clearance is low and caution should be used, etc. Detailed information may be supplied to the driver in some embodiments, such as the exact clearance that is calculated and error estimates, the point where the vehicle is likely to hang up, etc. If the hang-up is due to some low-hanging part, the driver may be able to secure the part at a higher level in order to safely make the crossing. For road-rail crossings or other road features where the profile is not constant across the width of the road, the information supplied to the driver may include advice on where to cross the road feature, width-wise, to maximize ground clearance, if the ground clearance is marginal if the road feature is crossed at at least one point. For example, if ground clearance is marginal if the road feature is crossed at the far-right side, but otherwise the ground clearance is acceptable, the driver may be advised to cross at a point other than the far-right of the roadway.

When the simplifying assumption is made that the hang-up decision can be executed as a planar process (by projecting the crossing profile surface, interference boundary, and vehicle underbody profile onto the centerline plane of the vehicle), the y-dimension can be dropped from the above definitions, resulting in the following equations

Crossing Profile Surface:

z=C(x)

Interference Point Cloud:

[symbol]

P [symbol] =((C)|ᵥ^{t=1}, [symbol] C [symbol] |ᵥ^{t=2}, . . . , [symbol] C [symbol] |ᵥ^{t=T}), given l_{wb} and dₜᵢᵣₑ

Interference Boundary Surface:

z=H(x)= [symbol] max [symbol] P(x) [symbol] |ₓ [symbol] for xεvehicle

Vehicle Underbody Profile:

z=U(x)

Ground Clearance:

G=U(x)−H(x)

Minimum Ground Clearance:

$$M G C = {min}_{x ∈ vehicle} G ( x )$$

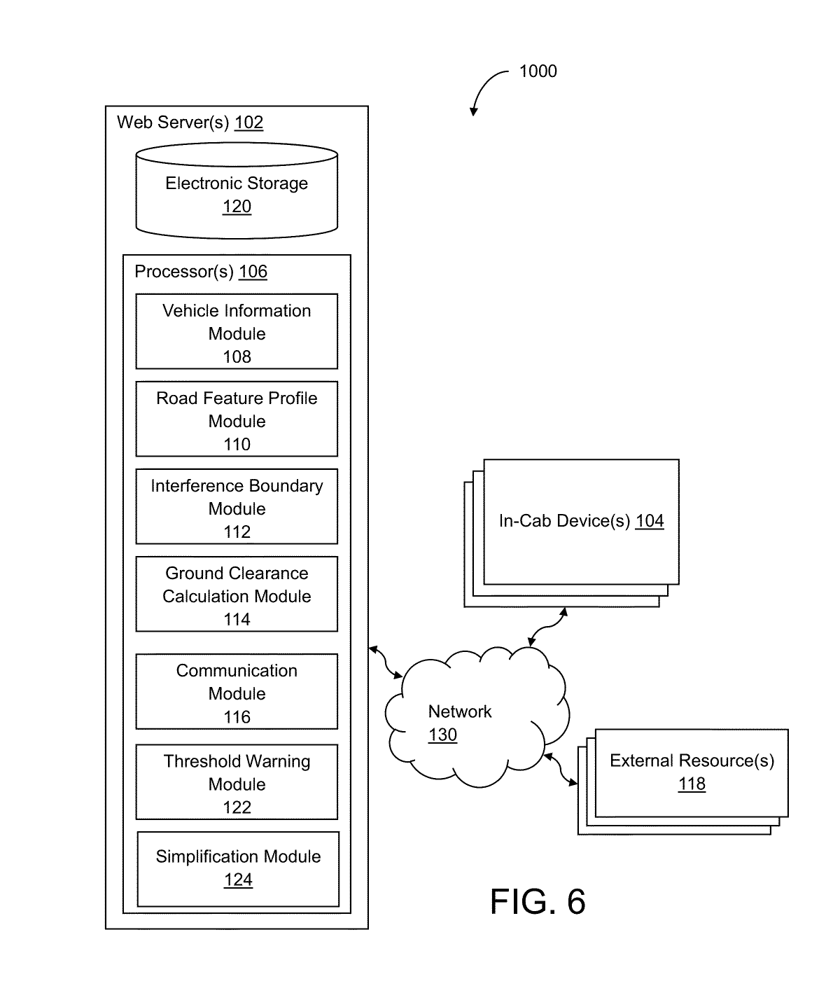

FIG. 5 illustrates the general architecture of the communications sub-system. The vehicle contains a device [100] having wireless communications capabilities. The device may be an in-cab telemetry device supplied by the vehicle owner to assist and monitor its drivers. There is considerable variety to such devices, but they generally include route mapping capabilities and localization via directly accessed GPS satellite data [300]. The device [100] may also be a Commercial Off-The-Shelf (COTS) smartphone. The driver may use a COTS localization and mapping software application, or a similar, customized application provided by the vehicle owner. Smartphones are also easily loaded with a barcode or QR code reader.

The communications sub-system has the capability to receive a few inputs from the driver. The most important input is the unique identifier of the vehicle, if the vehicle is unitary, such as a bus, or the unique identifier of the trailer, if it is the trailer that is at-risk for hang-ups, as is most frequently the case. The alphanumerical identifier may be typed into the device [100], or it may appear in machine-readable form on the body of the trailer [200]. Another anticipated input is a binary entry: “empty” or “full” to describe whether the trailer/vehicle is loaded or not, since this condition can affect ground clearance appreciably. At the initiation of a vehicle journey, the driver makes both inputs into his vehicle's device [100] by hard or soft keyboard or by scanning.

Currently, almost all devices suitable for use as subject device [100] obtain their connectivity via the nation's cellphone networks. Satellite communication systems exist, but are generally deemed too expensive for non-critical applications. The in-cab device [100] thus communicates wirelessly with cell towers [400] in its vicinity. All cell networks are capable of providing data communications via the internet [500]. In this manner, the in-cab device [100] communicates with the hang-up system's web server [800], first to upload the vehicle/trailer identifier and loading condition.

The web server [800] functions as a communications portal for the system and is where the hang-up engine makes its calculations. It is found on the internet via its IP address, and thus can be located anywhere. The web server [800] has access to two network-attached databases. One is a vehicle database [600] containing the dimension and profile information of the at-risk vehicle/trailer needed by the hang-up engine. This information is obtained and stored prior to being used for a specific calculation. As described earlier, this information may be obtained from manufacturer drawings and specifications, and/or from stopped vehicle or low-speed scanning using readily available technology during mandatory vehicle/trailer registration, periodic inspections and/or weigh station visits. This data may also be obtainable from at-speed scans of vehicles/trailers performed along roadways using more advanced technology and dedicated roadside infrastructure. Utilizing the former two methods, a database linking registration numbers with dimension and profile information may be assembled for most of the nation's at-risk vehicles fairly quickly.

A crossing database [700] is also attached to the web server [800]. This database contains geometric measurements of high-profile road-rail crossings. The Federal Railroad Administration (FRA) already has established unique identifiers and GPS coordinates for every public, and most private, crossings in the US. In general, crossing geometry information of sufficient quality for hang-up prediction does not exist currently. It may be obtained, though, through conventional survey team work. Crossing surveys may be performed by the FRA, the US DOT, state DOTs, and/or the railroads owning the track, according to budgetary and other considerations. The existing FRA database contains accident statistics for each crossing, creating the opportunity to prioritize survey work to those crossings that have proven to be the most problematic.

The communications sub-system may request, via the in-cab device [100] or via an office-based sub-system access point, a series of hang-up determinations in the course of planning a route. The more typical circumstance is the vehicle coming within a pre-set distance of a crossing. The vehicle's geo-location is periodically transmitted to the web server [800], which compares the vehicle location with the information in the crossing database [700]. If the vehicle is within range of the crossing, a hang-up determination calculation is automatically performed.

The result of the calculation is communicated back via the internet [500] and cell network [400] to the in-cab device [100] in near real-time. The probabilistic output of the hang-up engine is translated into a command or advisory message suitable for the driver. The vehicle owner or system administrator may determine the desired translation. Notionally, there may be three possible messages delivered: “Proceed”, “Proceed Slowly and with Caution” or “Do Not Cross”. When the calculated interference boundary indicates a tight clearance, slow speed crossings can mitigate suspension-based load movement that can result in a hang-up, and can offer the driver a viable option to back out of contact with the crossing surface. Messaging to the in-cab device [100] may be visual, using the device screen, and may also be audible, using in-cab device [100] speakers.

The sub-system requires some data-sharing with existing software used by the in-cab device [100]. At a minimum, the sub-system requires GPS or cell tower-derived geo-localization information from the device [100]. Greater integration with the device's mapping program provides additional functionality. For example, a “Do Not Cross” message may trigger a safe detour calculated and displayed by the device's mapping application.

Embodiments of the present invention can be implemented in a computer communicatively coupled to a network (for example, the Internet, an intranet, an internet, a WAN, a LAN, a SAN, etc.), another computer, or in a standalone computer. As is known to those skilled in the art, the computer can include a central processing unit (“CPU”) or processor, at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylist, etc.), or the like. In embodiments of the invention, the computer has access to at least one database over the network.

ROM, RAM, and HD are computer memories for storing computer-executable instructions executable by the CPU or capable of being complied or interpreted to be executable by the CPU. Within this disclosure, the term “computer readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a DASD array, magnetic tape, floppy diskette, optical storage device, or other appropriate computer-readable medium or storage device.

In one exemplary embodiment of the invention, the computer-executable instructions may be lines of C++, Java, JavaScript, HTML, Python, or any other programming or scripting code. Other software/hardware/network architectures may be used. For example, the functions of the present invention may be implemented on one computer or shared among two or more computers. In one embodiment, the functions of the present invention may be distributed in the network. Communications between computers implementing embodiments of the invention can be accomplished using any electronic, optical, radio frequency signals, or other suitable methods and tools of communication in compliance with known network protocols.

Additionally, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

It will be understood for purposes of this disclosure that a module is one or more computer processes, computing devices or both, configured to perform one or more functions. A module may present one or more interfaces that can be utilized to access these functions. Such interfaces include APIs, web services interfaces presented for a web services, remote procedure calls, remote method invocation, etc.

Embodiments disclosed herein provide systems and methods allowing members of an online community to determine personal rankings for other members of the online community to prioritize and personalize content generated by the other members of the online community that is presented to the member of the online community.

FIG. 6 depicts one embodiment of network topology 1000 for active detection for low ground clearance vehicles. The topology 1000 includes one or more in-cab devices 104 connected to web server(s) 102 over a network. In some embodiments, some elements of modules, 108, 110, 112, 114, 116, 122, 124 may reside on web server(s) 102 and others may reside on a third-party server or servers, or on in-cab devices 104 as a downloaded app or similar.

The network 130 may be a wired or wireless network such as the Internet, an intranet, a LAN, a WAN, a cellular network or another type of network. It will be understood that network 130 may be a combination of multiple different kinds of wired or wireless networks.

Web server 102 may be a server (or multiple servers, e.g. a cloud server) that is communicatively coupled to in-cab devices 104 via network 130. Web server 102 may include a processor 106, electronic storage 120, and interface configured to communicate data to and from in-cab devices 104.

In-cab devices 104 may be custom built devices or smart phones, laptop computers, desktop computers, tablets, netbooks, personal data assistants (PDA) and/or any other type of device that can process instructions and connect to network 130 or one or more portions of network 130. In-cab devices 104 may have a processor, memory, display, and/or interface configured to receive inputs from a driver or other end user.

Processor(s) 106 may include memory, e.g., read only memory (ROM) and random access memory (RAM), storing processor-executable instructions and one or more processors that execute the processor-executable instructions. In embodiments where processor(s) 106 includes two or more processors, the processors may operate in a parallel or distributed manner. In the illustrative embodiment, processor 106 may execute vehicle information module 108, road feature profile module 110, interference boundary module 112, ground clearance calculation module 114, communication module 116, threshold warning module 122, and/or simplification module 124.

Electronic storage 120 may include, but is not limited to a hard disc drive, an optical disc drive, and/or a flash memory drive and may be configured to store various data utilized by the modules.

External resources may include various sources of information external to the web server 102 and in-cab devices 104, for example various Internet resources from which vehicle and/or road feature information may be retrieved. These resources may include a road feature database and/or a vehicle database. In some embodiments, such databases may alternatively be located in electronic storage 120. External resources may also include identification tags physically located on vehicles and/or scanners local to road features and configured to read identification information from identification tags for use in retrieving vehicle information, for example from a vehicle information database or similar. Web-server 102 for example may retrieve vehicle information from a local scanner for use by the vehicle information module.

Vehicle information module 108 may be configured to obtain an underbody profile, wheel diameters, and inter-axle distances for a vehicle. Vehicle information module 108 may be further configured to obtain a loading condition of the vehicle. Vehicle information module 108 may also be configured to retrieve information from a vehicle database or other resource.

Road feature profile module 110 may be configured to obtain a geometric profile of a road feature. Road feature information module 110 may be configured to retrieve information from a road feature database or other resource.

Interference boundary module 112 may be configured to generate an interference boundary based on the road feature geometric profile and the wheel diameters and inter-axle distances of the vehicle, where the interference boundary is an upper envelope bounding the trajectories of all points on the road feature geometric profile as observed in a vehicle-fixed reference frame as the vehicle passes over the road feature.

Ground clearance calculation module 114 may be configured to calculate a ground clearance curve for the vehicle-road feature pair by comparing the underbody profile of the vehicle with the interference curve and to determine a minimum ground clearance over the ground clearance curve. Ground clearance calculation module 114 may also be configured to take the loading condition of the vehicle into account in calculating the ground clearance curve.

Communication module 116 may include a device that allows the web server 102 to communicate with other devices, e.g., the in-cab devices 104 and/or external resources 118, via network 130. Communication module 116 may include one or more wireless transceivers for performing wireless communication and/or one or more communication ports for performing wired communication. Communication module 116 may be configured to provide information regarding the minimum ground clearance to the vehicle's driver. Communication module may also be configured to provide information regarding the minimum ground clearance to the vehicle's driver by transmitting the information to a remote server associated with an in-cab wireless communication device.

Threshold warning module 122 may be configured to determine whether the minimum ground clearance is below a threshold level and, responsive to a determination that the minimum ground clearance is below the threshold level, to indicate a warning for a driver of the vehicle of a possible collision should the vehicle attempt to traverse the road feature.

Simplification module 124 may be configured to determine whether the height of the geometric profile of the road feature is constant across the width of the road and, responsive to a determination that the height of the geometric profile of the road feature is constant across the width of the road, to collapse the geometric profile to two dimensions by eliminating a road-width dimension from the geometric profile and to collapse the underbody profile of the vehicle to two dimensions by removing a vehicle-width dimension from the underbody profile and setting the vehicle height at each point from the front to the back of the vehicle as the lowest height along the width of the vehicle at that front-to-back point.

The description of the functionality provided by the different modules 108, 110, 112, 114, 116, 122, and 124 is for illustrative purposes, and is not intended to be limiting, as any of modules 108, 110, 112, 114, 116, 122, and 124 may provide more or less functionality than is described. For example, one or more of modules 108, 110, 112, 114, 116, 122, and 124 may be eliminated, and some or all of its functionality may be provided by other ones of modules 108, 110, 112, 114, 116, 122, and 124. Other functionality described with respect to the Figures and not explicitly indicated as being performed by one or more of modules 108, 110, 112, 114, 116, 122, and 124 may nevertheless be performed by one or more of those modules, or by other modules not expressly disclosed.

What is claimed is:

1. A vehicle ground collision prevention system, comprising:
one or more processing devices configured to execute computer program modules, the computer program modules comprising:
a vehicle information module configured to obtain an underbody profile, wheel diameters, and inter-axle distances for a vehicle;
a road feature profile module configured to obtain a geometric profile of a road feature;
an interference boundary module configured to generate an interference boundary based on the road feature geometric profile and the wheel diameters and inter-axle distances of the vehicle, wherein the interference boundary is an upper envelope bounding the trajectories of all points on the road feature geometric profile as observed in a vehicle-fixed reference frame as the vehicle passes over the road feature;
a ground clearance calculation module configured to calculate a ground clearance curve for the vehicle-road feature pair by comparing the underbody profile of the vehicle with the interference curve and to determine a minimum ground clearance over the ground clearance curve; and
a communication module configured to provide information regarding the minimum ground clearance to the vehicle's driver.

2. The vehicle ground collision prevention system of claim 1, wherein the vehicle information module is further configured to obtain a loading condition of the vehicle and the ground clearance calculation module is configured to take the loading condition of the vehicle into account in calculating the ground clearance curve.

3. The vehicle ground collision prevention system of claim 1, wherein the computer program modules further comprise a threshold warning module configured to determine whether the minimum ground clearance is below a threshold level and, responsive to a determination that the minimum ground clearance is below the threshold level, to indicate a warning for a driver of the vehicle of a possible collision should the vehicle attempt to traverse the road feature.

4. The vehicle ground collision prevention system of claim 1, wherein the computer program modules further comprise a simplification module configured to determine whether the height of the geometric profile of the road feature is constant across the width of the road and, responsive to a determination that the height of the geometric profile of the road feature is constant across the width of the road, to collapse the geometric profile to two dimensions by eliminating a road-width dimension from the geometric profile and to collapse the underbody profile of the vehicle to two dimensions by removing a vehicle-width dimension from the underbody profile and setting the vehicle height at each point from the front to the back of the vehicle as the lowest height along the width of the vehicle at that front-to-back point.

5. The vehicle ground collision prevention system of claim 1, wherein communication module is configured to provide information regarding the minimum ground clearance to the vehicle's driver by transmitting the information to a remote server associated with an in-cab wireless communication device.

6. The vehicle ground collision prevention system of claim 1, further comprising a road feature database and a vehicle database, wherein the vehicle information module is configured to retrieve information from the vehicle database and the road feature information module is configured to retrieve information from the road feature database.

7. The vehicle ground collision prevention system of claim 1, further comprising an identification tag physically located on the vehicle and a scanner local to the road feature configured to read identification information from the identification tag for use in retrieving vehicle information from a vehicle information database.

8. The vehicle ground collision prevention system of claim 1, further comprising a web server, wherein one or more of the computer program modules reside on the web server.

9. The vehicle ground collision prevention system of claim 8, wherein one or more of the computer program modules reside on a computing device local to the driver of the vehicle.

10. A vehicle ground collision prevention method, comprising:
acquiring a geometric profile of a road feature, the geometric profile defining a shape of the upper surface of the road feature;
acquiring wheel diameters and inter-axle distances for a vehicle;
generating an interference boundary based on the road feature geometric profile, wheel diameters and inter-axle distances, wherein the interference boundary is an upper envelope bounding the trajectories of all points on the road feature geometric profile as observed in a vehicle-fixed reference frame as the vehicle passes over the road feature;
acquiring an underbody profile of the vehicle, the underbody profile defining the shape of the lower surface of the vehicle;
calculating a ground clearance curve for the vehicle-road feature pair by comparing the underbody profile of the vehicle with the interference curve;
determining a minimum ground clearance over the ground clearance curve; and
providing information regarding the minimum ground clearance to the vehicle's driver.

11. The vehicle ground collision prevention method of claim 10, further comprising determining whether the minimum ground clearance is below a threshold level and, responsive to a determination that the minimum ground clearance is below the threshold level, indicating a warning for a driver of the vehicle of a possible collision should the vehicle attempt to traverse the road feature as part of providing information regarding the minimum ground clearance to the vehicle's driver.

12. The vehicle ground collision prevention method of claim 10, further comprising acquiring a loading condition for the vehicle, wherein calculating the ground clearance curve further comprises adjusting for loading condition by increasing calculated ground clearance under an unloaded condition and decreasing calculated ground clearance under a loaded condition.

13. The vehicle ground collision prevention method of claim 10, further comprising determining whether the height of the geometric profile of the road feature is constant across the width of the road and, responsive to a determination that the height of the geometric profile of the road feature is constant across the width of the road, collapsing the geometric profile to two dimensions by eliminating a road-width dimension from the geometric profile and collapsing the underbody profile of the vehicle to two dimensions by removing a vehicle-width dimension from the underbody profile and setting the vehicle height at each point from the front to the back of the vehicle as the lowest height along the width of the vehicle at that front-to-back point.

14. The vehicle ground collision prevention method of claim 10, wherein generating the interference boundary comprises, for each point in the geometric profile of the road feature, calculating a trajectory of the point in the vehicle-fixed reference frame as the vehicle passes over the point, the trajectory starting when the forward-most portion of the vehicle enters the space above the point and ending when the rear-most portion of the vehicle leaves the space above the point, determining at each point along the non-height dimension(s) of the underbody profile in the vehicle-fixed reference frame the greatest height of any point trajectory, and aggregating the greatest heights to form the interference boundary.

15. The vehicle ground collision prevention method of claim 10, wherein calculating a ground clearance curve for the vehicle-road feature pair comprises, at each point along the non-height dimension(s) of the underbody profile in the vehicle-fixed reference frame, subtracting the height of the interference boundary from the height of the underbody profile of the vehicle.

16. The vehicle ground collision prevention method of claim 14, further comprising determining whether the height of the geometric profile of the road feature is constant across the width of the road and, responsive to a determination that the height of the geometric profile of the road feature is constant across the width of the road, collapsing the geometric profile to two dimensions by eliminating a road-width dimension from the geometric profile and collapsing the underbody profile of the vehicle to two dimensions by removing a vehicle-width dimension from the underbody profile and setting the vehicle height at each point from the front to the back of the vehicle as the lowest height along the width of the vehicle at that front-to-back point, wherein the non-height dimension(s) of the underbody profile comprises front-to-back length only.

17. The vehicle ground collision prevention method of claim 10, wherein acquiring the geometric profile of the road feature and the the underbody profile of the vehicle comprises retrieving the geometric profile and the underbody profile from databases.

18. The vehicle ground collision prevention method of claim 10, wherein providing information regarding the minimum ground clearance to the vehicle's driver comprises transmitting the information to a remote server associated with an in-cab wireless communication device.
